(19) United States
(12) Patent Application Publication
(10) Pub. No.: US 2009/0174220 A1
(43) Pub. Date: Jul. 9, 2009

(54) Vehicle Body Structure with Linking Bracket for a Vehicle Side Pillar

(75) Inventor: Derek Y. Guo, Troy, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/970,014

(22) Filed: Jan. 7, 2008

(51) Int. Cl. B60R 27/00

(52) U.S. Cl. 296/187.12; 296/203.01; 296/204

(57) ABSTRACT

Vehicle body structure is provided that includes a generally upright frame pillar, such as a b-pillar having an inner pillar member and an outer pillar member outboard of and connected to the inner pillar member. The frame pillar defines a cavity. A load-bearing linking bracket at least partially laterally spans a portion of the cavity. The linking bracket has a surface generally inclined from an outboard side to an inboard side of the frame pillar. The linking bracket is configured to at least partially absorb a substantially lateral impact force and, via the inclined surface, to provide a moment of force that at least partially counteracts an opposing moment of force provided by the frame pillar due to the impact force.

### TECHNICAL FIELD

The invention relates to vehicle body structure with a load-bearing linking bracket for a vehicle side pillar.

### BACKGROUND OF THE INVENTION

Vehicle side pillars are designed in part to absorb side impact loads. Some vehicle bodies have a b-pillar that is generally laterally aligned with a driver's seat assembly and an opposing b-pillar aligned with a passenger seat assembly. The b-pillars are operatively connected to a floor assembly that supports the seat assemblies.

### SUMMARY OF THE INVENTION

Vehicle body structure is provided that includes a generally upright frame pillar, such as a b-pillar that defines a cavity. The frame pillar may have an inner pillar member and an outer pillar member outboard of and connected to the inner pillar member, with the connected inner and outer pillar members defining the cavity therebetween. A load-bearing linking bracket at least partially laterally spans a portion of the cavity. The linking bracket has a surface generally inclined toward the inner pillar member. The vehicle body structure also includes a floor assembly and a generally wedge-shaped gusset operatively connected to the frame pillar in lateral alignment with the load-bearing linking bracket and having a surface generally declining from the frame pillar to the floor assembly. A seat assembly is secured to the floor assembly inboard of the frame pillar. The linking bracket is configured to at least partially absorb a substantially lateral impact force and, via the inclined surface, to provide a moment of force on the b-pillar, the gusset and the floor assembly in response to the lateral impact on the frame pillar that at least partially counteracts an opposing moment of force provided by the frame pillar on the gusset and the floor assembly due to the impact force.

The gusset may be generally wedge-shaped and operatively connected to the frame pillar in lateral alignment with the load-bearing linking bracket with a surface generally declining from the frame pillar to the floor assembly.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration in fragmentary view of a first embodiment of vehicle body structure with a linking bracket welded to a b-pillar inner pillar member and with a gusset welded to the linking bracket and generally inboard of the b-pillar inner member;

FIG. 2 is a schematic partially cross-sectional illustration in fragmentary side view of the vehicle body structure of FIG. 1 including a floor assembly and a seat assembly and illustrating a deformable barrier; and

FIG. 3 is a schematic partially cross-sectional illustration in fragmentary side view of the vehicle body structure of FIG. 2 illustrating the deformable barrier impacting the b-pillar to create a moment by the b-pillar on the gusset and the floor assembly and an opposing moment created by the linking bracket.

### DESCRIPTION OF THE PREFERRED EMBODIMENTS

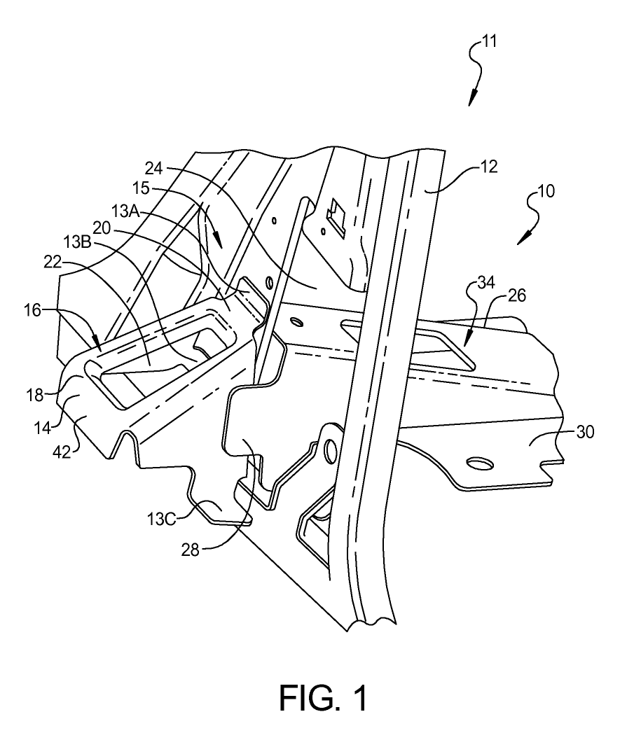

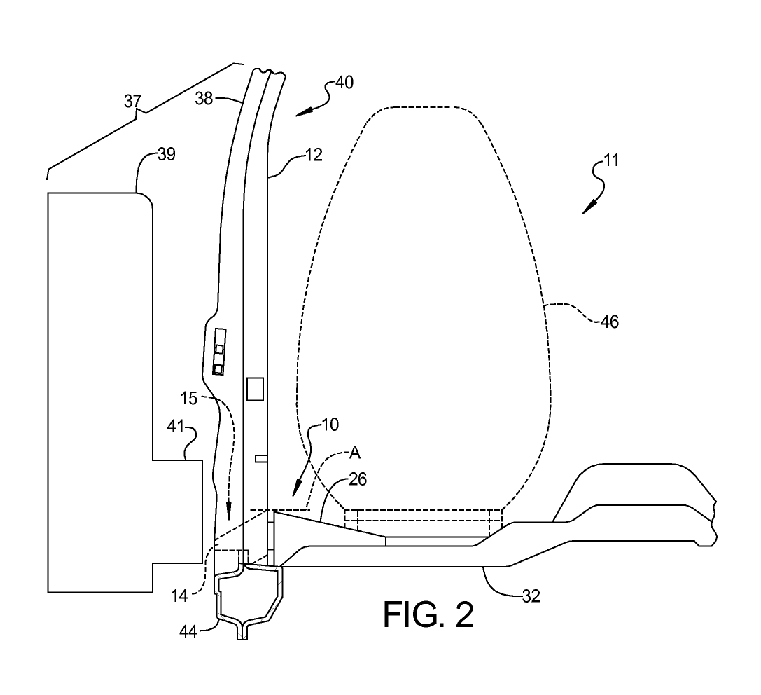

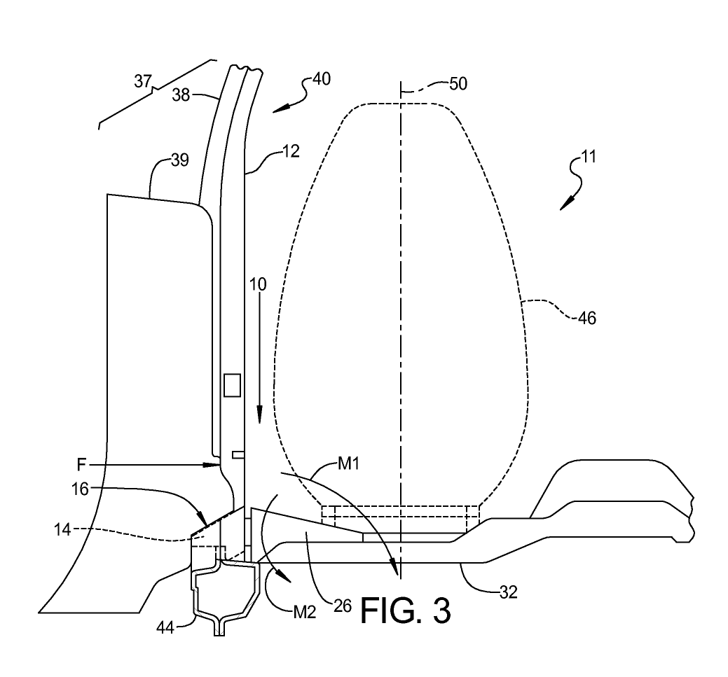

Referring to the drawings, wherein like reference numbers refer to like components, FIG. 1 shows a portion of vehicle body structure 10 that includes a b-pillar inner member 12. The vehicle body structure 10 partially forms a vehicle 11. A load-bearing linking bracket 14 is welded or otherwise fastened outboard of the b-pillar inner member 12 at various tab portions 13A, 13B, 13C of the linking bracket 14. As discussed below, the linking bracket 14 absorbs impact force and offsets rotation of b-pillar 40 (shown in FIGS. 2 and 3) to reduce or prevent intrusion of the b-pillar 40 laterally inward or inboard. As used herein, an “inboard” direction is a direction toward the center of the vehicle and an “outboard” direction is a direction away from the center of the vehicle.

The b-pillar inner member 12 partially defines a cavity 15 which the linking bracket 14 laterally spans. The linking bracket 14 has an upward-facing inclined surface 16 that generally is inclined from (i.e., slopes upward from) an outer or outboard portion 18 to an inner or inboard portion 20 of the linking bracket 14. That is, the surface 16 is inclined toward the b-pillar inner member 12. The linking bracket 14 may be any generally stiff, load-bearing material, such as an aluminum alloy or steel. The linking bracket 14 defines an opening 22 in the inclined surface 16 to reduce the weight of the linking bracket 14 while still maintaining adequate component strength for the purposes described herein. The b-pillar inner member 12 also defines an opening 24 adjacent the linking bracket 14.

A generally wedge-shaped gusset 26 is laterally aligned with the linking bracket 14 generally inboard of the inner pillar member 12. Other flanges, such as flange 30 of the gusset 26 are used to weld or otherwise fasten the gusset 26 to a floor assembly 32, shown in FIG. 2. The gusset 26 has an arm portion 28 that extends through the opening 24 and is welded or otherwise fastened to the linking bracket 14. An opposing side of the gusset 26 opposite the arm portion 28 may weld or otherwise fasten to the inner pillar member 12. The gusset 26 has an upward-facing declining surface 34 that generally slopes downward in an inboard direction from the inner b-pillar member 12.

Referring to FIG. 2, an assembly 37 of a deformable impact member 39 and the vehicle 11 is illustrated. The deformable impact member 39 has a protruding portion 41 at a height with respect to the b-pillar 12 to align with the linking bracket 14. For example, the impact member 39 may be designed for impact testing purposes and may be of predetermined dimensions. The inner b-pillar member 12 is welded to an outer b-pillar member 38 to form a generally upright b-pillar 40, also referred to herein as a frame pillar. It should be appreciated that the b-pillar 40 may be a unitary component, such as a hydroformed tube, rather than having discrete inner and outer members. The outer b-pillar member 38 further defines the cavity 15 to house the linking bracket 14 therein. Linking bracket 14 need not span the entire cavity 15 either laterally or longitudinally (as shown in FIG. 1), although in the embodiment of FIGS. 1-3 the linking bracket spans the entire cavity 15 laterally. An outboard surface 42 (shown in FIG. 1) of the linking bracket 14 is welded or otherwise fastened to an inner surface of the outer b-pillar member 38. The b-pillar 40 is welded or otherwise connected to a rocker 44, shown in cross-sectional view, which runs longitudinally along the vehicle 11 and also partially supports the floor assembly 32. As is evident in FIG. 1, the linking bracket 14 is laterally aligned with the gusset 26. As is evident in FIGS. 1 and 2, the respective portions of the linking bracket 14 and the gusset 26 adjacent the inner pillar member 12 are substantially level with one another (i.e., are at substantially the same vertical location with respect to a horizontal level A shown in FIG. 2). A vehicle seat assembly 46 is fastened to the floor assembly 32 in lateral alignment with the gusset 26 and the linking bracket 14.

Referring to FIG. 3, the deformable impact member 39 is shown impacting the b-pillar 40 with an impacting force F distributed over a broad vertical range of the b-pillar 40 but represented as force F acting on the b-pillar 40 above the linking bracket 14. The impacting force F begins to deform the b-pillar 40 as illustrated, but the laterally-aligned linking bracket 14 and gusset 26 allow a greater lateral load to be absorbed, minimizing intrusion of the b-pillar 40 and the barrier 39 laterally toward the seat assembly 46. The impacting force F causes the b-pillar 40 to create a clockwise moment M1 about the gusset 26. The inclined surface 16 of the linking bracket 14 acts as a reaction surface when the impact member 39 comes into contact with it, creating a counterclockwise moment M2 acting on both the b-pillar 40 and the attached gusset 26. The opposing moment M2 at least partially offsets the moment M1 to reduce or prevent buckling of the floor assembly 26 and intrusion of the b-pillar 40 and the impact member 39 toward the seat assembly 46. The lateral distance of the innermost portion of the b-pillar 40 or the impact member 39 to a centerline 50 of the seat assembly 46 is expected to be reduced due to the linking bracket 14.

While the best modes for carrying out the invention have been described in detail, those familiar with the art to which this invention relates will recognize various alternative designs and embodiments for practicing the invention within the scope of the appended claims.

1. Vehicle body structure comprising:
a generally upright frame pillar having an inner pillar member and an outer pillar member outboard of and connected to the inner pillar member; wherein the connected inner and outer pillar members define a cavity therebetween; and
a load-bearing linking bracket at least partially laterally spanning a portion of the cavity and having a surface generally inclined from the outer pillar member toward the inner pillar member.

2. The vehicle body structure of claim 1, wherein the bracket is configured to provide a moment of force in response to a generally lateral impact on the frame pillar to at least partially counteract an opposing moment of force by the frame pillar due to the impact.

3. The vehicle body structure of claim 1, further comprising:
a floor assembly; and
a generally wedge-shaped gusset operatively connected to the inner pillar member in lateral alignment with the load-bearing linking bracket and having a surface generally declining from the frame pillar to the floor assembly.

4. The vehicle body structure of claim 3, wherein the inner pillar member defines an opening; wherein a portion of the gusset extends through the opening; and wherein the portion of the gusset is rigidly connected to the bracket.

5. The vehicle body structure of claim 3, wherein the linking bracket and the gusset are configured such that the surface of the linking bracket generally inclined from the outer pillar member to the inner pillar member and the surface of the gusset generally declining from the frame pillar to the floor assembly are substantially level with one another at the inner pillar member.

6. The vehicle body structure of claim 1, wherein the linking bracket defines an opening in the surface.

7. The vehicle body structure of claim 1, wherein the frame pillar is a b-pillar.

8. Vehicle body structure comprising:
a generally upright frame pillar defining an internal cavity;
a floor assembly; wherein the frame pillar is positioned laterally outboard of and operatively connected to the floor assembly; and
a load-bearing linking bracket positioned in the cavity to substantially laterally span the cavity generally level with the floor assembly and defining a surface sloping generally upward from an outboard side of the frame pillar to an inboard side of the frame pillar.

9. The vehicle body structure of claim 8, further comprising:
a gusset operatively connected to the frame pillar and to the floor assembly in lateral alignment with the load-bearing linking bracket; wherein the linking bracket provides a first moment on the gusset opposing a second moment on the gusset provided by the frame pillar, both moments provided in response to a generally lateral impact on the frame pillar.

10. The vehicle body structure of claim 8, further comprising:
a seat assembly connected to the floor assembly inboard of the frame pillar and in lateral alignment with the linking bracket; wherein the surface of the linking bracket sloping generally upward provides the moment of force on the gusset in response to the lateral impact on the frame pillar to at least partially counteract the opposing moment of force by the frame pillar on the gusset to thereby control deformation of the frame pillar inward toward the seat assembly.

11. The vehicle body structure of claim 8, further comprising:
a seat assembly connected to the floor assembly inboard of the frame pillar and in lateral alignment with the linking bracket; wherein the linking bracket at least partially absorbs a laterally impact load on the frame pillar to control deformation of the frame pillar inward toward the seat assembly.

12. Vehicle body structure comprising:
a b-pillar having an inner pillar portion and an outer pillar portion generally laterally outboard of the inner pillar portion; wherein the inner pillar portion and the outer pillar portion define a cavity therebetween;
a linking bracket at least partially spanning the cavity laterally between the inner pillar portion and the outer pillar portion and having a surface sloping generally upward from an outboard portion of the surface to an inboard portion of the surface, the linking bracket thereby providing a first moment of force on the b-pillar at the linking bracket in a direction opposing a second moment of force of the b-pillar above the linking bracket in response to a laterally inboard impact on the b-pillar.

13. The vehicle body structure of claim 12 further comprising:
a floor assembly;
a generally wedge-shaped gusset operatively connected to the b-pillar in lateral alignment with the linking bracket and having a gusset surface generally declining from the b-pillar to the floor assembly; wherein the first and second moments of force act on the gusset.

14. The vehicle body structure of claim 13, wherein the linking bracket and the gusset are configured such that the surface of the linking bracket generally inclined from the outboard portion to the inboard portion and the gusset surface generally declining from the b-pillar to the floor assembly are substantially level with one another at the b-pillar.
